(19) United States
(12) Patent Application Publication
(10) Pub. No.: US 2019/0324702 A1
(43) Pub. Date: Oct. 24, 2019

(54) ELECTRONIC MESSAGE BOARD ASSEMBLY

(71) Applicant: Richard Wagner, Hicksville, NY (US)

(72) Inventor: Richard Wagner, Hicksville, NY (US)

(21) Appl. No.: 15/961,203

(22) Filed: Apr. 24, 2018

(51) Int. Cl. G06F 3/14; G06F 3/041; H04R 1/02

(52) U.S. Cl. CPC G06F 3/14; H04B 1/38; H04R 1/028; G06F 3/041

(57) ABSTRACT

An electronic message board assembly includes a mobile electronic device is carried by a first user. The mobile electronic device has a first transceiver and the first transceiver transmits a communication signal. The mobile electronic device stores data comprising communication software for generating an electronic message that is broadcast on the communication signal. A display unit is mounted in a building such that the display unit is visible to a second user. The display unit is in wireless electrical communication with the mobile electronic device such that the display unit receives the communication signal. Moreover, the display unit displays indicia correlating to the electronic message from the electronic device to visually communicate the electronic message to the second user. In this way the second user may receive the electronic message when the second user is not actively using a mobile electronic device.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to message board devices and more particularly pertains to a new message board device for communicating an electronic message to an individual that is not actively using a mobile electronic device.

### BRIEF SUMMARY OF THE INVENTION

An embodiment of the disclosure meets the needs presented above by generally comprising a mobile electronic device is carried by a first user. The mobile electronic device has a first transceiver and the first transceiver transmits a communication signal. The mobile electronic device stores data comprising communication software for generating an electronic message that is broadcast on the communication signal. A display unit is mounted in a building such that the display unit is visible to a second user. The display unit is in wireless electrical communication with the mobile electronic device such that the display unit receives the communication signal. Moreover, the display unit displays indicia correlating to the electronic message from the electronic device to visually communicate the electronic message to the second user. In this way the second user may receive the electronic message when the second user is not actively using a mobile electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an electronic message board assembly according to an embodiment of the disclosure.

FIG. 2 is a perspective in-use view of an embodiment of the disclosure.

FIG. 3 is a schematic view of an embodiment of the disclosure.

### DETAILED DESCRIPTION OF THE INVENTION

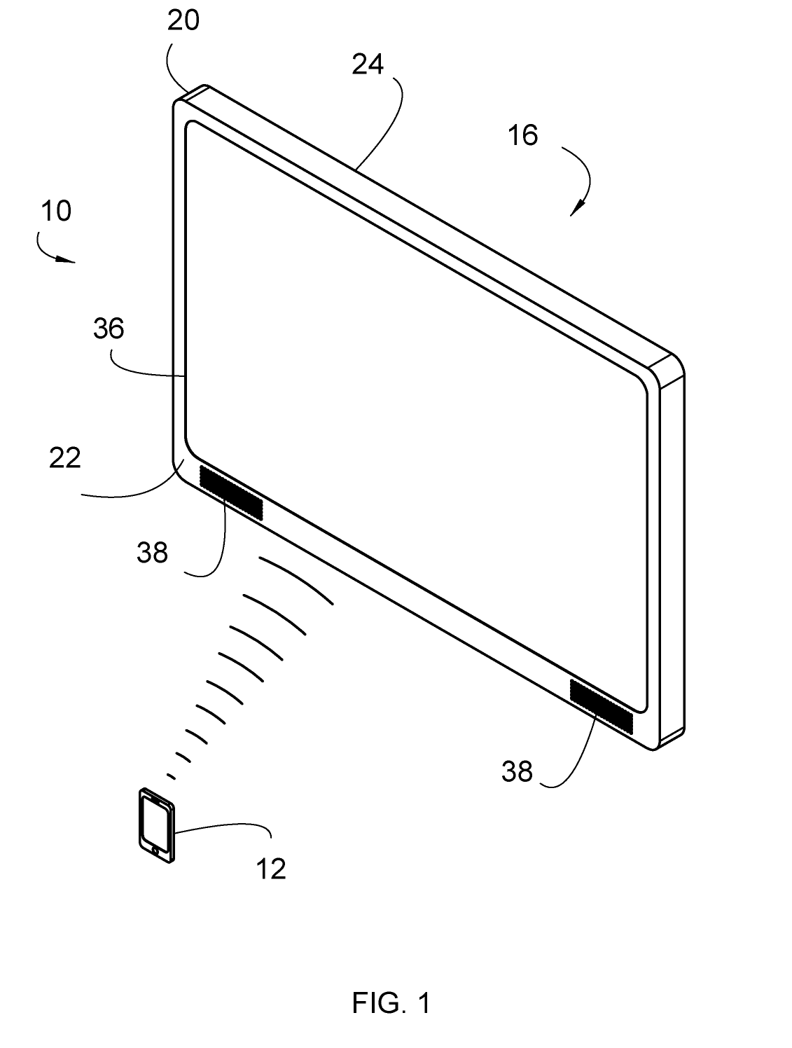

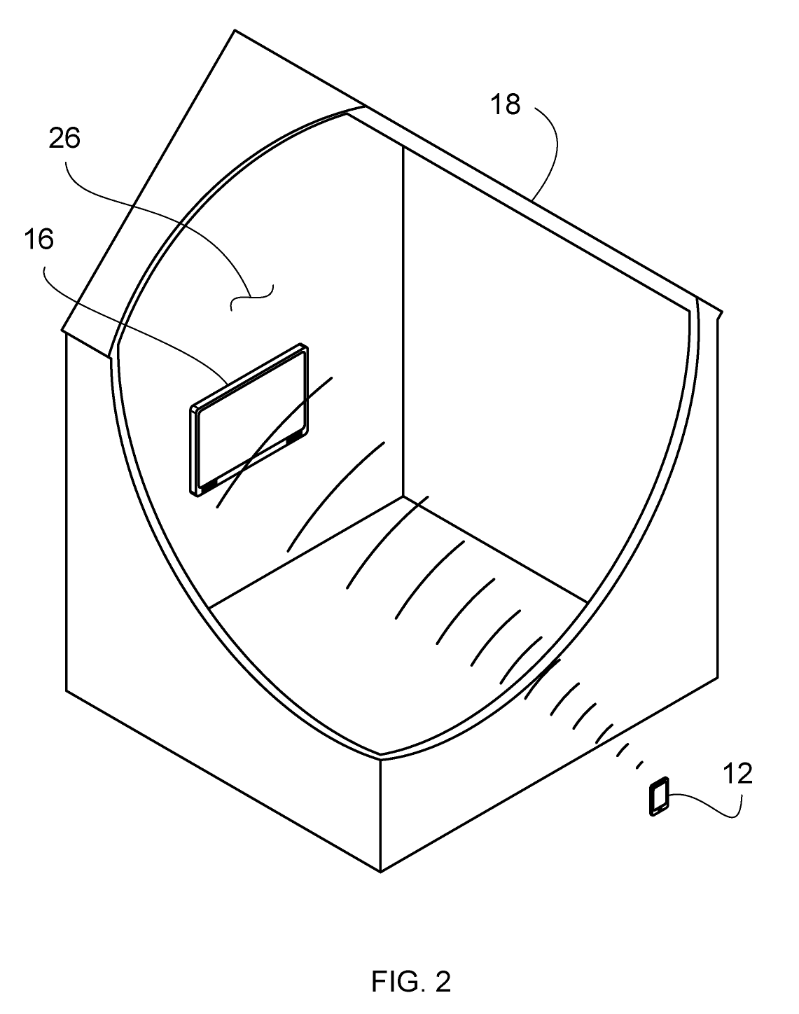

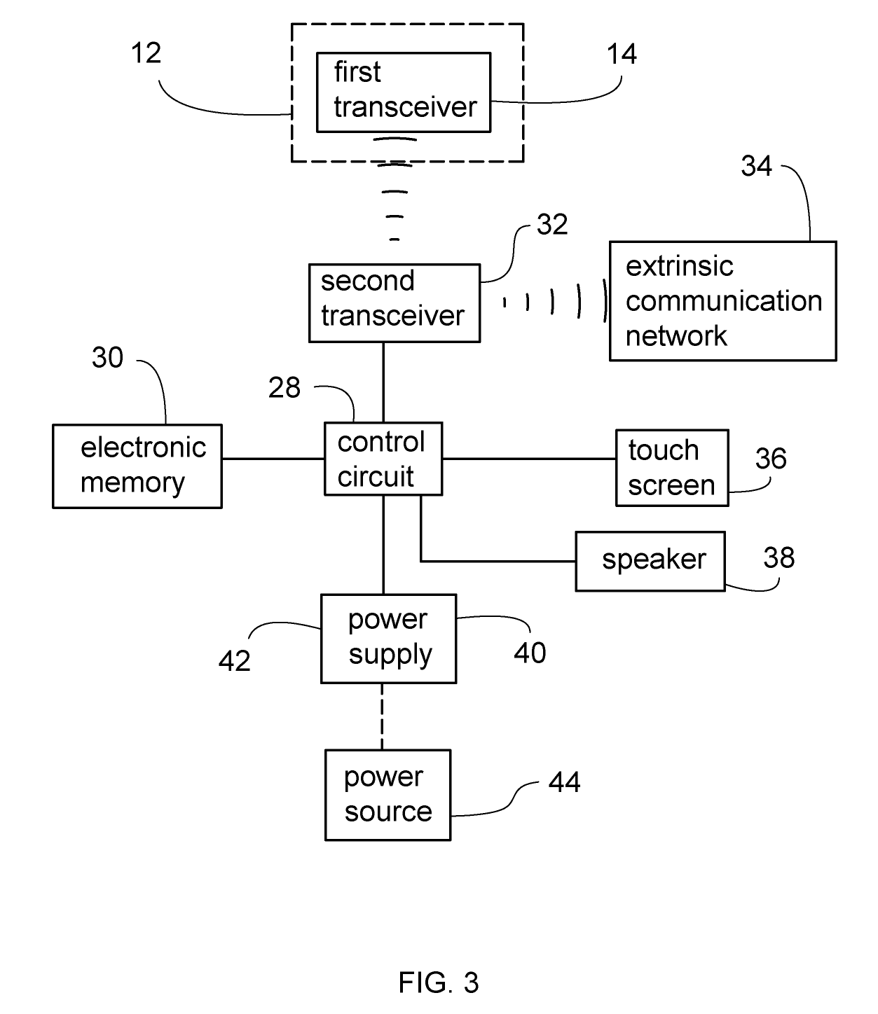

With reference now to the drawings, and in particular to FIGS. 1 through 3 thereof, a new message board device embodying the principles and concepts of an embodiment of the disclosure and generally designated by the reference numeral 10 will be described.

As best illustrated in FIGS. 1 through 3, the electronic message board assembly 10 generally comprises a mobile electronic device 12 that may be carried by a first user. The mobile electronic device 12 has a first transceiver 14 and the mobile electronic device 12 may be a smart phone or the like. The first transceiver 14 transmits a communication signal and the first transceiver 14 may comprise a radio frequency transceiver or the like. The mobile electronic device 12 stores data comprising communication software for generating an electronic message that is broadcast on the communication signal. The communication software may be a smart phone app or any other type of operational software.

A display unit 16 is provided and the display unit 16 is mounted in a building 18, such as a home or the like. Additionally, the display unit 16 is positioned in a high visibility area in the building 18 such that the display unit 16 is visible to a second user and other individuals in the building 18. The display unit 16 is in wireless electrical communication with the mobile electronic device 12 such that the display unit 16 receives the communication signal. Additionally, the display unit 16 displays indicia correlating to the electronic message from the electronic device to visually communicate the electronic message to the second user. In this way the second user may receive the electronic message when the second user is not actively using a mobile electronic device 12.

The display unit 16 comprises a housing 20 that has a front side 22 and a back side 24, and the back side 24 is mounted to a support surface 26, such as a wall or the like, in the building 18. A control circuit 28 is positioned within the housing 20 and an electronic memory 30 is positioned within the housing 20. The electronic memory 30 is electrically coupled to the control circuit 28 and the electronic memory 30 stores data comprising operational software. The operational software may include a database of authorized users and avatars that are assigned to each authorized user.

A second transceiver 32 is positioned within the housing 20 and the second transceiver 32 is electrically coupled to the control circuit 28. The second transceiver 32 is in electrical communication with the first transceiver 14 such that the second transceiver 32 receives the communication signal. Additionally, the second transceiver 32 is in electrical communication with an extrinsic communication network 34, such as the internet or the like, via a wireless internet router or other conventional internet service provision. The second transceiver 32 may be a radio frequency transceiver or the like and the second transceiver 32 may employ a WPAN signal and Bluetooth communication protocols.

A touch screen 36 is coupled to the front side 22 of the housing 20 and the touch screen 36 is electrically coupled to the control circuit 28. The touch screen 36 displays the indicia correlating to the electronic message in the communication signal. Moreover, the touch screen 36 is manipulated by the second user to control the operational software. The touch screen 36 may be an LCD touch screen 36 or any other electronic touch screen 36 and the touch screen 36 may have a width of at least 45.0 inches.

The touch screen 36 may display the avatars for each of the authorized users and any icons relating to a graphical user interface for the operational software. A plurality of speakers 38 is each coupled to the front side 22 of the housing 20 to emit audible sound outwardly therefrom. Each of the speakers 38 is electrically coupled to the control circuit 28 and each of the speakers 38 may be electronic speakers 38 of any conventional design. The operational software facilitates the electronic message to be visually communicated in a variety of ways, including but not being limited to, text messages, black and white or color images, video with or without audio, and any other web based sharing architecture. Additionally, the operational software facilitates an electronic message, such as a text message, email and other conventional electronic communication, to be sent from the touch screen 36 to the mobile electronic device 12.

A power supply 40 is positioned in the housing 20 and the power supply 40 is electrically coupled to the control circuit 28. The power supply 40 comprises a power cord 42 extending outwardly from the housing 20 and is electrically coupled to a power source 44. The power source 44 may be a female electrical outlet, the electrical system of the building 18 and any other source of electrical energy.

In use, the housing 20 is mounted in the building 18 and positioned at a location that is highly visible to people in the building 18. The electronic device is manipulated by the first user to communicate the electronic message to the display unit 16. The touch screen 36 displays the electronic message in visual form to communicate the electronic message to the second user when the second user is not actively using a mobile electronic device 12. In this way the display unit 16 enhances communication efficiency between the first user and the second user with respect to mobile electronic device 12s. Additionally, any electronic data may be broadcast to the display unit 16, such as a document explaining a cooking recipe, a video and any other electronic data. In this way the document, video or other electronic data may be displayed in a larger format on the display unit 16 compared to the electronic device.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An electronic message board assembly being configured to display information received from a smart phone, said assembly comprising:
a mobile electronic device being carried by a first user, said mobile electronic device having a first transceiver, said first transceiver transmitting a communication signal, said mobile electronic device storing data comprising communication software for generating an electronic message being broadcast on said communication signal; and
a display unit being mounted in a building wherein said display unit is configured to be visible to a second user, said display unit being in wireless electrical communication with said mobile electronic device such that said display unit receives said communication signal, said display unit displaying indicia correlating to said electronic message from said electronic device to visually communicate said electronic message to the second user thereby facilitating the second user to receive said electronic message when the second user is not actively using a mobile electronic device, said display unit comprising
a housing having a front side and a back side, said back side being mounted to a support surface in the building,
a control circuit being positioned within said housing,
an electronic memory being positioned within said housing, said electronic memory being electrically coupled to said control circuit, said electronic memory storing data comprising operational software;
a touch screen being coupled to said front side of said housing, said touch screen being electrically coupled to said control circuit, said touch screen displaying said indicia correlating to said electronic message in said communication signal, said touch screen being manipulated by the second user to control said operational software.

2. (canceled)

3. (canceled)

4. (canceled)

5. The assembly according to claim 1, further comprising a second transceiver being positioned within said housing, said second transceiver being electrically coupled to said control circuit, said second transceiver being in electrical communication with said first transceiver such that said second transceiver receives said communication signal.

6. (canceled)

7. The assembly according to claim 1, further comprising a plurality of speakers, each of said speakers being coupled to said front side of said housing wherein each of said speakers is configured to emit audible sound outwardly therefrom, each of said speakers being electrically coupled to said control circuit.

8. The assembly according to claim 1, further comprising a power supply being positioned in said housing, said power supply being electrically coupled to said control circuit, said power supply comprising a power cord extending outwardly from said housing and being electrically coupled to a power source.

9. An electronic message board assembly being configured to display information received from a smart phone, said assembly comprising:
a mobile electronic device being carried by a first user, said mobile electronic device having a first transceiver, said first transceiver transmitting a communication signal, said mobile electronic device storing data comprising communication software for generating an electronic message being broadcast on said communication signal; and
a display unit being mounted in a building wherein said display unit is configured to be visible to a second user, said display unit being in wireless electrical communication with said mobile electronic device such that said display unit receives said communication signal, said display unit displaying indicia correlating to said electronic message from said electronic device to visually communicate said electronic message to the second user thereby facilitating the second user to receive said electronic message when the second user is not actively using a mobile electronic device, said display unit comprising:
a housing having a front side and a back side, said back side being mounted to a support surface in the building;
a control circuit being positioned within said housing;
an electronic memory being positioned within said housing, said electronic memory being electrically coupled to said control circuit, said electronic memory storing data comprising operational software;
a second transceiver being positioned within said housing, said second transceiver being electrically coupled to said control circuit, said second transceiver being in electrical communication with said first transceiver such that said second transceiver receives said communication signal;
a touch screen being coupled to said front side of said housing, said touch screen being electrically coupled to said control circuit, said touch screen displaying said indicia correlating to said electronic message in said communication signal, said touch screen being manipulated by the second user to control said operational software;
a plurality of speakers, each of said speakers being coupled to said front side of said housing wherein each of said speakers is configured to emit audible sound outwardly therefrom, each of said speakers being electrically coupled to said control circuit; and
a power supply being positioned in said housing, said power supply being electrically coupled to said control circuit, said power supply comprising a power cord extending outwardly from said housing and being electrically coupled to a power source.
